(19) United States
(12) Patent Application Publication
(10) Pub. No.: US 2018/0124431 A1
(43) Pub. Date: May 3, 2018

(54) IN-LOOP POST FILTERING FOR VIDEO ENCODING AND DECODING

(71) Applicant: Magic Pony Technology Limited, Londo (GB)

(72) Inventors: Sebastiaan Van Leuven, London (GB); Zehan Wang, London (GB); Robert David Bishop, London (GB)

(21) Appl. No.: 15/855,731

(22) Filed: Dec. 27, 2017

Related U.S. Application Data
(63) Continuation of application No. PCT/GB2017/051040, filed on Apr. 13, 2017.

(30) Foreign Application Priority Data
Apr. 15, 2016 (GB) 1606682.1

(51) Int. Cl. H04N 19/82; H04N 19/513; H04N 19/117; H04N 19/139; H04N 19/31; H04N 19/436; H04N 19/176

(52) U.S. Cl. CPC H04N 19/82; H04N 19/513; H04N 19/117; H04N 19/124; H04N 19/31; H04N 19/436; H04N 19/176; H04N 19/139

(57) ABSTRACT

The present disclosure relates to an enhanced in-loop filter for an encoding or decoding process. According to an aspect of the disclosure, there is provided method of post filtering video data in an encoding or decoding process using hierarchical algorithms, the method comprising steps of: receiving one or more input pictures of video data; transforming, using one or more hierarchical algorithms, the one or more input pictures of video data to one or more pictures of transformed video data; and outputting the one or more transformed pictures of video data; wherein the transformed pictures of video data are enhanced for use within the encoding or decoding loop and wherein the method is performed in-loop within the encoding or decoding process.

### CROSS REFERENCE TO RELATED APPLICATIONS

This application is a continuation of, and claims priority to, International Patent Application No. PCT/GB2017/051040, filed on Apr. 13, 2017, which claims priority to United Kingdom Application No. GB 1606682.1, filed on Apr. 15, 2016, the contents of both of which are incorporated herein by reference.

### FIELD

The present disclosure relates to an enhanced in-loop filter for an encoding or decoding process. For example, the present disclosure relates to the use of trained hierarchical algorithms to enhance video data within an encoding or decoding loop for use in interprediction or intraprediction.

### BACKGROUND

### Background—Video Compression

FIG. 1 illustrates the generic parts of a video encoder. Video compression technologies reduce information in pictures by reducing redundancies available in the video data. This can be achieved by predicting the image (or parts thereof) from neighbouring data within the same frame (intraprediction) or from data previously signalled in other frames (interprediction). The interprediction exploits similarities between pictures in a temporal dimension. Examples of such video technologies include, but are not limited to, MPEG2, H.264, HEVC, VP8, VP9, Thor, Daala. In general, video compression technology comprises the use of different modules. To reduce the data, a residual signal is created based on the predicted samples. Intra-prediction 121 uses previously decoded sample values of neighbouring samples to assist in the prediction of current samples. The residual signal is transformed by a transform module 103 (for example, Discrete Cosine Transform or Fast Fourier Transforms may be used). This transformation allows the encoder to remove data in high frequency bands, where humans notice artefacts less easily, through quantisation 105. The resulting data and all syntactical data is entropy encoded 125, which is a lossless data compression step. The quantized data is reconstructed through an inverse quantisation 107 and inverse transformation 109 step. By adding the predicted signal, the input visual data 101 is re-constructed 113. To improve the visual quality, filters, such as a deblocking filter 111 and a sample adaptive offset filter 127 can be used. The picture is then stored for future reference in a reference picture buffer 115 to allow exploiting the difference static similarities between two pictures. It is also stored in a decoded picture buffer 129 for future output as a reconstructed picture 113. The motion estimation process 117 evaluates one or more candidate blocks by minimizing the distortion compared to the current block. One or more blocks from one or more reference pictures are selected. The displacement between the current and optimal block(s) is used by the motion compensation 119, which creates a prediction for the current block based on the vector. For interpredicted pictures, blocks can be either intra- or interpredicted or both.

Interprediction exploits redundancies between frames of visual data. Reference frames are used to reconstruct frames that are to be displayed, resulting in a reduction in the amount of data required to be transmitted or stored. The reference frames are generally transmitted before the frames of the image to be displayed. However, the frames are not required to be transmitted in display order. Therefore, the reference frames can be prior to or after the current image in display order, or may even never be shown (i.e., an image encoded and transmitted for referencing purposes only). Additionally, interprediction allows to use multiple frames for a single prediction, where a weighted prediction, such as averaging is used to create a predicted block.

FIG. 2 illustrates a schematic overview of the Motion Compensation (MC) process part of the interprediction. In motion compensation, reference blocks 201 from reference frames 203 are combined to produce a predicted block 205 of visual data. This predicted block 205 of visual data is subtracted from the corresponding input block 207 of visual data in the frame currently being encoded 209 to produce a residual block 211 of visual data. It is the residual block 211 of visual data, along with the identities of the reference blocks 203 of visual data, which are used by a decoder to reconstruct the encoded block of visual data 207. In this way the amount of data required to be transmitted to the decoder is reduced.

The Motion Compensation process has as input a number of pixels of the original image, referred to as a block, and one or more areas consisting of pixels (or subpixels) within the reference images that have a good resemblance with the original image. The MC subtracts the selected block of the reference image from the original block. To predict one block, the MC can use multiple blocks from multiple reference frames, through a weighted average function the MC process yield a single block that is the predictor of the block from the current frame. The frames transmitted prior to the current frame can be located before or after the current frame in display order.

The more similarities the predicted block 205 has with the corresponding input block 207 in the picture being encoded, the better the compression efficiency will be, as the residual block 211 will not be required to contain as much data. Therefore, matching the predicted block 205 as close as possible to the current picture is beneficial for good encoding performances. Consequently, the most optimal, or closely matching, reference blocks 201 in the reference pictures 203 can be found, which is known as motion estimation.

FIG. 3 illustrates a visualisation of the motion estimation process. An area 301 of a reference frame 303 is searched for a data block 305 that matches the block currently being encoded 307 most closely, and a motion vector 309 can be determined that relates the position of this reference block 305 to the block currently being encoded 307. The motion estimation will evaluate a number of blocks in the reference frame 301. By applying a translation between the frame currently being encoded and the reference frame, any candidate block in the reference picture 303 can be evaluated.

When the most optimal block is found, or at least a block that is sufficiently close to the current block, the motion compensation creates the residual block, which is used for transformation and quantisation. The difference in position between the current block and the optimal block in the reference image is signalled in the form of a motion vector, which also indicates the identity of the reference image being used as a reference.

FIG. 4 illustrates an example of intraprediction. Intraprediction exploits redundancies within frames of visual data. As neighbouring pixels have a high degree of similarity, neighbouring pixels can be used to predict the current block 401. This can be done be extrapolating the pixel values of neighbouring pixels 403 on the block to be encoded (current block) 401. This can be achieved by mechanisms such as intra block copy (IBC). IBC looks within the already decoded parts 405 of the current picture 407 for an area that has a high resemblance with the current block

### Background—Motion Post-Filtering

Deblocking filters aim at smoothing out the edges of blocks within a picture. Pictures are split into blocks to apply prediction and transformation on smaller blocks rather than on the full picture itself. For example, in H.264 blocks of 8×8 are used, while HEVC allow for different block sizes. In general, it is not important what size of blocks have been used.

In the original input picture, neighbouring pixels tend to have similar values. However, for different blocks the motion estimation and motion compensation processes will yield different predictions . Because different neighbouring blocks are processed independently, the effect of the quantization after transformation of the residual will be different for neighbouring pixels in different blocks. This will produce different results for neighbouring pixels and produce the visual distortion known as blocking artefact. Deblocking filters aim to smooth out the area around the block edges such that these become less visible.

Applying this de-blocking completely outside the decoding loop as an independent post-filter can introduce temporally instabilities as the effect of the transformation/quantisation process will differ due to different predictions. Furthermore, pictures that have had the de-blocking process applied to them will often have more similarities with future input pictures. Therefore, applying the de-blocking filter in-loop as part of the encoding process before the reference pictures buffer will improve the prediction of new pictures, such that residual pictures will have less data. The generic encoder of FIG. 1 shows a de-blocking filter being applied before the pictures are stored in the reference picture buffer and before the decoded pictures are send to the output.

Additionally, the HEVC standard introduces a Sample Adaptive Offset filter (SAO). This filter operates after the deblocking filter. The SAO applies different processing, such as different filter coefficients, depending on the categorization of samples. The goal is to preserve edges and reduce banding artefacts.

Finally, Adaptive Loop Filters have been proposed in the past. These filters are non-square shaped (e.g., diamond) and designed to remove time invariant artefacts due to compression.

These filters are example of non-hierarchical in-loop filters, which are applied in-loop during the encoding process to enhance reconstructed video data after the inverse quantisation and inverse transformation steps.

### Background—Machine Learning Techniques

Machine learning is the field of study where a computer or computers learn to perform classes of tasks using the feedback generated from the experience or data gathered that the machine learning process acquires during computer performance of those tasks.

Machine learning can be broadly classed as supervised and unsupervised approaches, although there are some approaches such as reinforcement learning and semi-supervised learning which have special rules, techniques or approaches.

Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and may use unlabelled data sets.

Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled.

Unsupervised machine learning may be applied to solve problems where an unknown data structure might be present in the data. As the data is unlabelled, the machine learning process is required to operate to identify implicit relationships between the data for example by deriving a clustering metric based on internally derived information.

Semi-supervised learning may be applied to solve problems where there is a partially labelled data set, for example where only a subset of the data is labelled. Semi-supervised machine learning makes use of externally provided labels and objective functions as well as any implicit data relationships.

When initially configuring a machine learning system the machine learning algorithm can be provided with some training data or a set of training examples, in which each example may be a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features. The user must also determine the desired structure of the learned or generalised function, for example whether to use support vector machines or decision trees.

### SUMMARY

According to a first aspect, there is provided a method of filtering video data in an encoding or decoding process using hierarchical algorithms, the method comprising steps of: receiving one or more input pictures of video data; transforming, using one or more hierarchical algorithms, the one or more input pictures of video data to one or more pictures of transformed video data; and outputting the one or more transformed pictures of video data; wherein the transformed pictures of video data are enhanced for use within the encoding or decoding loop.

Enhancing reconstructed input pictures of video data that have gone through the inverse transformation or inverse quantisation steps of decoding can result in a better performance of the motion compensation process or higher visual quality of output pictures when compared with using the unenhanced reconstructed input pictures. The pictures are enhanced using hierarchical algorithms that have been pre-trained to generate substantially optimised enhanced pictures, either for visual display or for use in motion compensation.

Optionally, the method is performed in-loop within the encoding and/or decoding process.

Applying the hierarchical algorithms to the reconstructed input pictures in-loop within an encoding or decoding process allows the enhanced pictures to be used in other in-loop processes.

Optionally, a plurality of hierarchical algorithms is applied to the one or more input pictures of video data.

Using multiple hierarchical algorithms can generate multiple enhanced pictures from a single reconstructed input picture, each of which can be optimised in a different way for use in different conditions, such as visual display or as a reference picture in motion compensation. Additionally, multiple hierarchical algorithms can be used on different (or overlapping) parts of a single input picture dependent on the content of those parts to output a single transformed picture.

Optionally, two or more of the plurality of hierarchical algorithms share one or more layers.

By sharing layers between algorithms that have processes in common, the common processes only need to be performed once, which can result in an increase in computational efficiency.

Optionally, the transformed pictures of video data are enhanced for use in motion compensation.

Optimising the transformed pictures for use in motion compensation can reduce the size of the resulting residual block by increasing the similarity between the predicted and input blocks of visual data in the motion compensation process.

Optionally, the method further comprises the step of applying a non-hierarchical in-loop filter to the one or more input pictures of video data.

Non-hierarchical algorithms, for example a deblocking or Sample Adaptive Offset filter, can additionally be applied to the input pictures of video data to remove artefacts, such as blocking or banding, from the input picture.

Optionally, the non-hierarchical in-loop filter is incorporated into the one or more hierarchical algorithms.

The functions of the non-hierarchical algorithms can be incorporated into the one or more hierarchical algorithms to simplify the enhancement process. The hierarchical algorithm can then also be trained to optimise the non-hierarchical functions.

Optionally, the method further comprises the step of applying a non-hierarchical in-loop filter to the one or more transformed pictures of video data.

Applying the non-hierarchical algorithms after the hierarchical algorithms can reduce the complexity of the hierarchical algorithms. The hierarchical algorithms may in some circumstances underperform on gradients and introduce sharp edges, which will be smoothed out by the non-hierarchical algorithms.

Optionally, the non-hierarchical in-loop filter comprises at least one of a deblocking filter; a Sample Adaptive offset filter; an adaptive loop filter; or a Wiener filter.

Deblocking SAO filters, ALF and Wiener filters can remove blocking, colour banding, and general artefacts from the input picture or transformed picture.

Optionally, the one or more transformed pictures of video data are stored in one or more buffers after being output by the one or more hierarchical algorithms.

Storing the enhanced transformed pictures in a buffer allows for their use in other processes subsequent to the transformation by the hierarchical algorithms.

Optionally, the one or more buffers comprises at least one of: a reference picture buffer; and output picture buffer; or a decoded picture buffer.

A reference picture buffer or decoded picture buffer can be used to store enhanced pictures for use in interprediction of subsequently encoded input frames. An output picture buffer can store the enhanced picture for later output to a display.

Optionally, one or more further hierarchical algorithms are applied to the one or more transformed pictures of video data prior to the one or more transformed pictures of video data being stored in at least one of the one or more buffers.

Applying further hierarchical algorithms to the transformed pictures before outputting them to a buffer can allow for further, buffer specific optimisation of the transformed picture. This is beneficial in situations where the mathematically optimised picture for motion compensation has different properties to the visually optimised picture for output to a visual display.

Optionally, the one or more further hierarchical algorithms comprises a plurality of further hierarchical algorithms.

Applying multiple further hierarchical algorithms can generate additional enhanced pictures with different properties. For example, different hierarchical algorithms can be applied to different parts of the reconstructed input picture depending on properties of those parts. This can be more efficient, depending on the input signal.

Optionally, two or more of the plurality of further hierarchical algorithms are applied in parallel.

Applying the multiple hierarchical algorithms in parallel can increase the computational efficiency and reduce the time required to produce the enhanced picture or pictures.

Optionally, two or more of the plurality of further hierarchical algorithms share one or more layers.

Some layers of the hierarchical algorithm can be shared to prevent having to repeat the any common processing steps multiple times.

Optionally, the transformed pictures of video data are enhanced for use in intraprediction.

Optionally, the transformed pictures of video data are output to an intraprediction module.

Intraprediction predicts blocks of visual data in a picture based on knowledge of other blocks in the same picture. Optimising the reconstructed video data for use in intraprediction can increase the efficiency of the intraprediction process.

Optionally, the one or more hierarchical algorithms comprises a plurality of hierarchical algorithms.

Using multiple hierarchical algorithms can generate multiple enhanced pictures from a single reconstructed input picture, each of which can be optimised in a different way for use in different conditions.

Optionally, the plurality of hierarchical algorithms is applied at a separate set of input blocks in the input picture.

Multiple hierarchical algorithms can be used on different (or overlapping) parts of a single input picture dependent on the content of those parts to output a single transformed picture.

Optionally, a separate hierarchical algorithm is applied to each of two or more input blocks of video data in the input picture of video data.

The hierarchical algorithms applied to each block can in general be different, so that content specific algorithms can be used on blocks of different content in order to increase the adaptability and overall efficiency of the method.

Optionally, one or more of the one or more hierarchical algorithms are selected from a library of pre-trained hierarchical algorithms.

Optionally, the selected one or more hierarchical algorithms are selected based on metric data associated with the one or more input pictures of video data.

Selecting hierarchical algorithms from a library based on comparing properties of the input picture with metadata associated with the pre-trained algorithms, such as the content they were trained on, increases the adaptability of the method, and can increase the computational efficiency of the process.

Optionally, the method further comprises the step of pre-processing the input picture of video data to determine which of the one or more hierarchical algorithms are selected.

Pre-processing the input picture (before the encoding process) at a neural network analyser/encoder allows the required hierarchical algorithm to be selected in parallel to the rest of the encoding process, reducing the computational effort required during the in-loop processing. It also allows for the optimisation of the number of coefficients to send to the network in terms of bit rate and effective quality gain.

Optionally, the step of pre-processing the input picture further comprises determining one or more updates to the selected one or more hierarchical algorithms.

Determining updates to the hierarchical algorithms based on knowledge of the input frame can enhance the quality of the output transformed pictures.

Optionally, the one or more hierarchical algorithms are content specific.

Content specific hierarchical algorithms can be more efficient at transforming pictures in comparison to generic hierarchical algorithms.

Optionally, the one or more hierarchical algorithms were developed using a learned approach.

Optionally, the learned approach comprises training the hierarchical algorithm on uncompressed input pictures and reconstructed decoded pictures.

By training the hierarchical algorithm on sets of known input pictures and substantially optimum reconstructed pictures, the hierarchical algorithm can be substantially optimised for outputting an enhanced picture. Using machine learning to train the hierarchical algorithms can result in more efficient and faster hierarchical algorithms than otherwise.

Optionally, the hierarchical algorithm comprises: a nonlinear hierarchical algorithm; a neural network; a convolutional neural network; a layered algorithm; a recurrent neural network; a long short-term memory network; a multi-dimensional convolutional network; a memory network; or a gated recurrent network.

The use of any of a non-linear hierarchical algorithm; neural network; convolutional neural network; recurrent neural network; long short-term memory network; multi-dimensional convolutional network; a memory network; or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of frames, as the algorithm maintains some sort of state or memory of the changes in motion. This can additionally result in a reduction of error rates.

Optionally, the method is performed at a node within a network.

Optionally, metadata associated with the one or more hierarchical algorithms is transmitted across the network.

Transmitting meta data in or alongside the encoded bit stream from one network node to another allows the receiving network node to easily determine which hierarchical algorithms have been used in the encoding process and/or which hierarchical algorithms are required in the decoding process.

Optionally, one or more of the one or more hierarchical algorithms are transmitted across the network.

In the event that a receiving network node does not have a specific hierarchical algorithm present, it may be transmitted to that node in or alongside the encoded bit stream.

Herein, the word picture is preferably used to connote an array of picture elements (pixels) representing visual data such as: a picture (for example, an array of luma samples in monochrome format or an array of luma samples and two corresponding arrays of chroma samples in, for example, 4:2:0, 4:2:2, and 4:4:4 colour format); a field or fields (e.g. interlaced representation of a half frame: top-field and/or bottom-field); or frames (e.g. combinations of two or more fields).

Herein, the word block is preferably used to connote a group of pixels, a patch of an image comprising pixels, or a segment of an image. This block may be rectangular, or may have any form, for example comprise an irregular or regular feature within the image. The block may potentially comprise pixels that are not adjacent.

Herein, the word hierarchical algorithm is preferably used to connote any of: a nonlinear hierarchical algorithm; a neural network; a convolutional neural network; a layered algorithm; a recurrent neural network; a long short-term memory network; a multi-dimensional convolutional network; a memory network; or a gated recurrent network.

### BRIEF DESCRIPTION OF DRAWINGS

Embodiments will now be described, by way of example only and with reference to the accompanying drawings having like-reference numerals, in which:

FIG. 1 illustrates an example of a generic encoder;

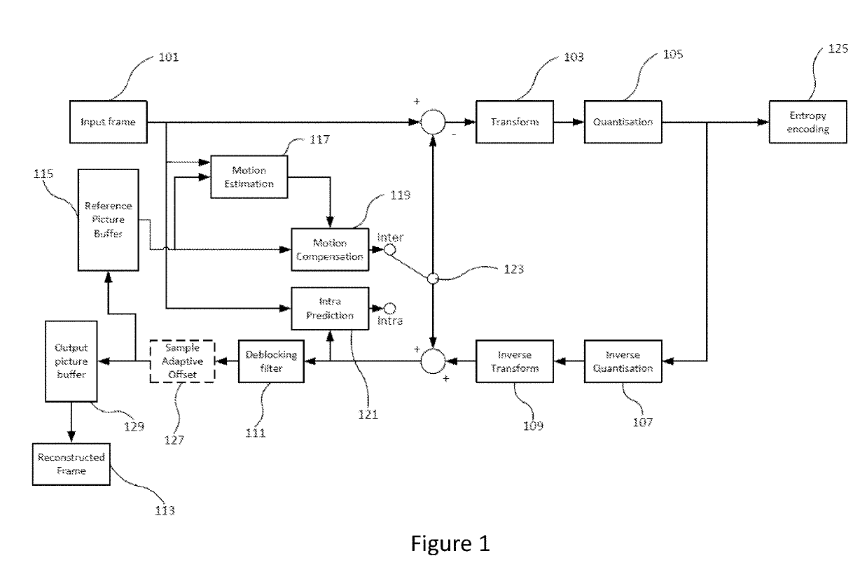

FIG. 2 illustrates an example of a motion compensation process;

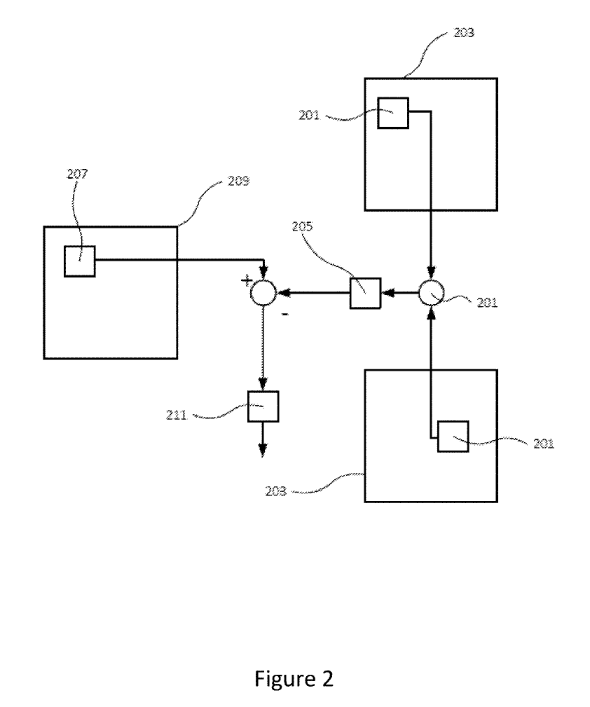

FIG. 3 illustrates an example of a motion estimation process;

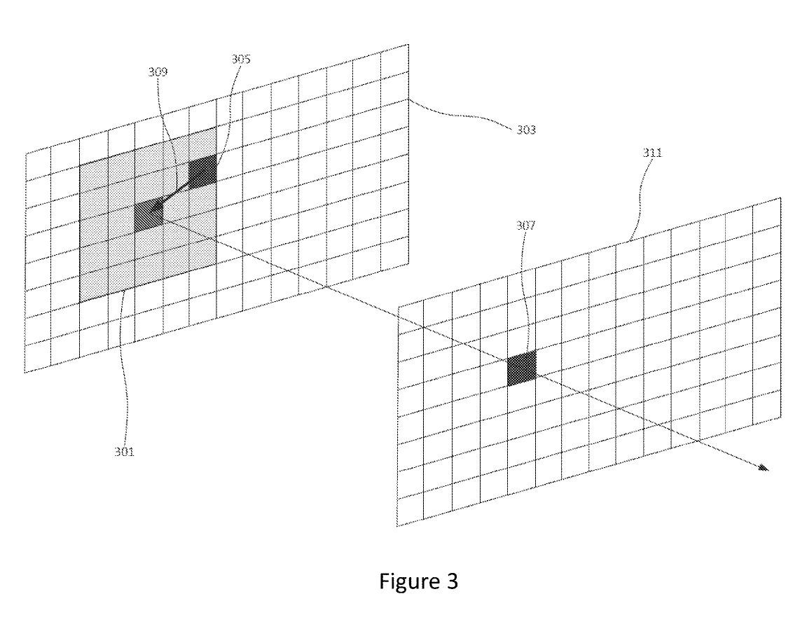

FIG. 4 illustrates an example of an intraprediction process;

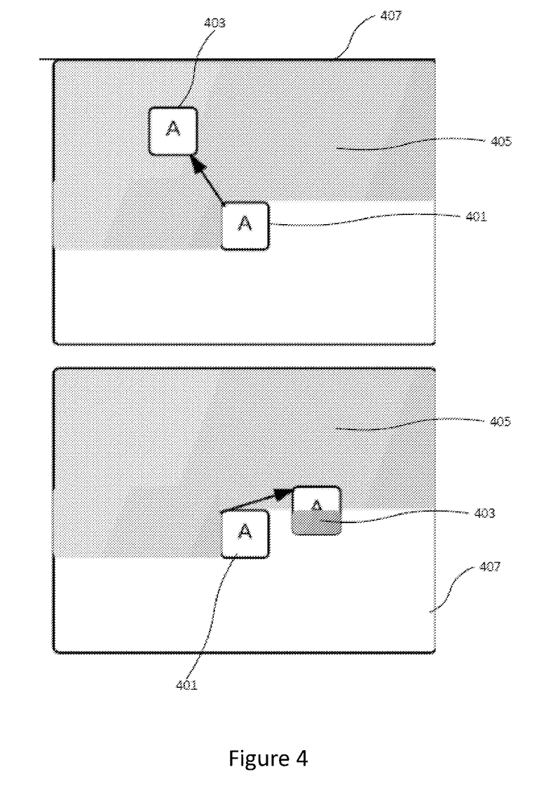

FIG. 5 illustrates an embodiment of an enhanced encoding process using an in-loop hierarchical algorithm;

FIG. 6 illustrates an another example embodiment of an enhanced encoding process incorporating a deblocking filter and a Sample Adaptive Offset filter into the in-loop hierarchical algorithm;

FIG. 7 illustrates an embodiment of an enhanced encoding process using multiple in-loop hierarchical algorithms;

FIG. 8 illustrates another example embodiment of an enhanced encoding process using multiple in-loop hierarchical algorithms;

FIG. 9 illustrates an embodiment of an enhanced encoding process using multiple in-loop hierarchical algorithms in parallel;

FIG. 10 illustrates an embodiment of an enhanced encoding process using multiple in-loop hierarchical algorithms with a pre-processing module;

FIG. 11 illustrates an embodiment of an enhanced encoding process using an in-loop hierarchical algorithm to enhance a reference picture;

FIG. 12 illustrates another example embodiment of an enhanced encoding process using an in-loop hierarchical algorithm to enhance a reference picture;

FIG. 13 illustrates an embodiment of an enhanced encoding process using multiple in-loop hierarchical algorithms to enhance a reference picture;

FIG. 14 illustrates an embodiment of another example enhanced encoding process using multiple in-loop hierarchical algorithms to enhance a reference picture; and

FIG. 15 illustrates an embodiment of an enhanced encoding process using an in-loop hierarchical algorithm to enhance the intraprediction process.

FIG. 16 illustrates an embodiment of an apparatus for post filtering video data in an encoding or decoding process using hierarchical algorithms.

### DETAILED DESCRIPTION

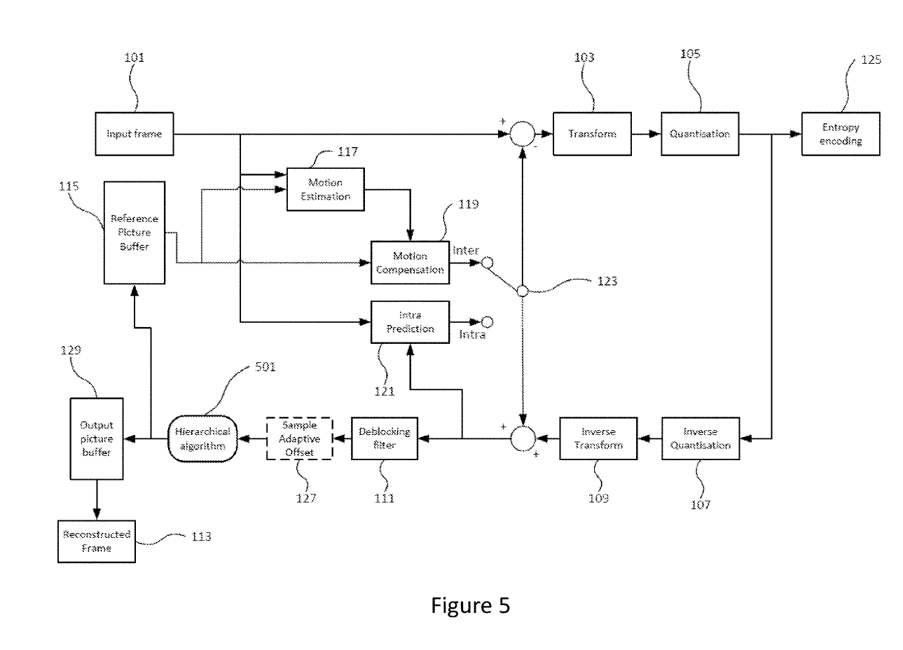

Referring to FIG. 5, an exemplary embodiment of the proposed in-loop post filtering will now be described.

FIG. 5 illustrates an embodiment of an enhanced encoding process using an in-loop hierarchical algorithm. An original input frame 101 is used as an input for a transform module 103, motion estimation 117, motion compensation 119 and intraprediction 121. The motion estimation 117 and motion compensation 119 processes are used to generate a motion vector and residual blocks of data from knowledge of reference frames stored in a reference picture buffer 115 that relate reference blocks of video data in the reference frames to input blocks of video data in the input frame 101. Intraprediction 121 uses knowledge of the whole input frame 101 to generate a motion vector and residual blocks of video data that relate input blocks of video data to other input blocks of video data in the input frame 101. The residual blocks of video data are transformed by the transform module 103, for example, using Discrete Cosine Transforms or Fast Fourier Transforms. The transformed residual blocks are then quantised using a quantisation module 105 to remove higher frequency bands, resulting in quantised data. The quantized data is reconstructed through an inverse quantisation 107 and inverse transformation 109 step. By adding the predicted signal, as determined by the interprediction and intraprediction 121, the input visual data 101 is substantially re-constructed. To improve the visual quality, filters, such as a deblocking filter 111 and a sample adaptive offset filter 127 are applied to the reconstructed video data. This can remove artefacts, for example blocking and banding artefacts. After the application of these filters, a pre-trained hierarchical algorithm 501 is applied to the deblocked and debanded video data in order to improve the visual quality of the reconstructed picture 113 stored in the output picture buffer 129 and the reference picture stored in the reference picture buffer 115. The improved reference picture stored in the reference picture buffer 115 can then be used in the motion estimation 117 and motion compensation 119 processes for future input frames 101. In effect the hierarchical algorithm 501 provides an additional, trainable processing and filtering step that can enhance the quality of the reconstructed frame of video data 113.

The hierarchical algorithm 501 is trained using uncompressed input pictures and reconstructed decoded pictures. The training aims at optimizing the algorithm using a cost function describing the difference between the uncompressed and reconstructed pictures. Given the amount of training data, the training can be optimized through parallel and distributed training. Furthermore, the training might comprise of multiple iterations to optimize for different temporal positions of the picture relative to the reference pictures.

The hierarchical algorithm 501 can be selected from a library of hierarchical algorithms based on metric data or metadata relating to the input picture 101, for example the content of the input picture, the resolution of the input picture, the quality of the input picture, the position of some blocks within the input picture, or the temporal layer of the input picture. The hierarchical algorithms stored in the library have been pre-trained on known pairs of input pictures and reconstructed pictures that have had a deblocking filter 111 and SAO 127 filter applied to them in order to optimise the improved reference picture and reconstructed frame 113. If no suitable hierarchical algorithm is present in the library a generic pre-trained hierarchical algorithm can be used instead. The training may be performed in parallel or on a distributed network.

In an example arrangement of this embodiment the hierarchical algorithm 501 is applied to the reconstructed video data before the deblocking filter 111 and SAO filter 127. In this case, the hierarchical algorithm 501 has been pre-trained to output video data that is optimised for use in the deblocking filter 111 and SAO filter 127, while providing enhanced video data for use in interprediction. This can result in a reduced complexity of the hierarchical algorithm 501, and any sharp edges introduced by the hierarchical algorithm 501 can be smoothed out by the deblocking filter 111 and SAO filter 127. In a further example embodiment, the hierarchical algorithm 501 is applied to the reconstructed video data after the deblocking filter 111 has been applied, but before the SAO filter 127 has been applied.

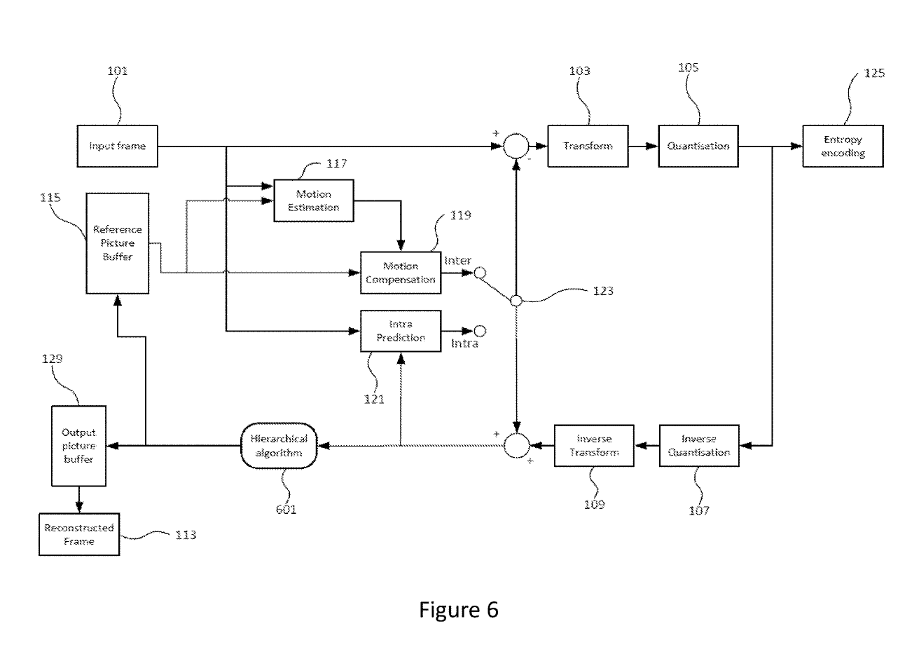

FIG. 6 illustrates an another example embodiment of an enhanced encoding process incorporating a deblocking filter and a Sample Adaptive Offset filter into the in-loop hierarchical algorithm 601. In this embodiment, the functions of the deblocking filter and SAO filter have been incorporated into the hierarchical algorithm 601. The reconstructed frame obtained from adding the inverse transformed residual blocks to the predicted picture output by the motion compensation 119 and intraprediction 121 processes is directly input into the hierarchical algorithm 601. The output of the hierarchical algorithm 601 is an enhanced picture, which has been filtered to be substantially enhanced, for example by being deblocked and debanded.

The hierarchical algorithm 601 can be selected from a library of hierarchical algorithms based on metric data or metadata relating to the input picture 101 or reconstructed picture, for example the content of the picture, the resolution of the picture, the quality of the picture, or the temporal position of the picture. The hierarchical algorithms stored in the library have been pre-trained on known pairs of input pictures and reconstructed pictures that have not had either a deblocking filter or SAO filter applied to them in order to optimise the enhanced reference picture and reconstructed frame 113. If no suitable hierarchical algorithm is present in the library a generic pre-trained hierarchical algorithm can be used instead.

In this embodiment, the deblocking filter and SAO filter are implemented as part of the hierarchical algorithm. These functions can be performed in the first layers of the algorithm, but in general can take place in any of the layers of the algorithm.

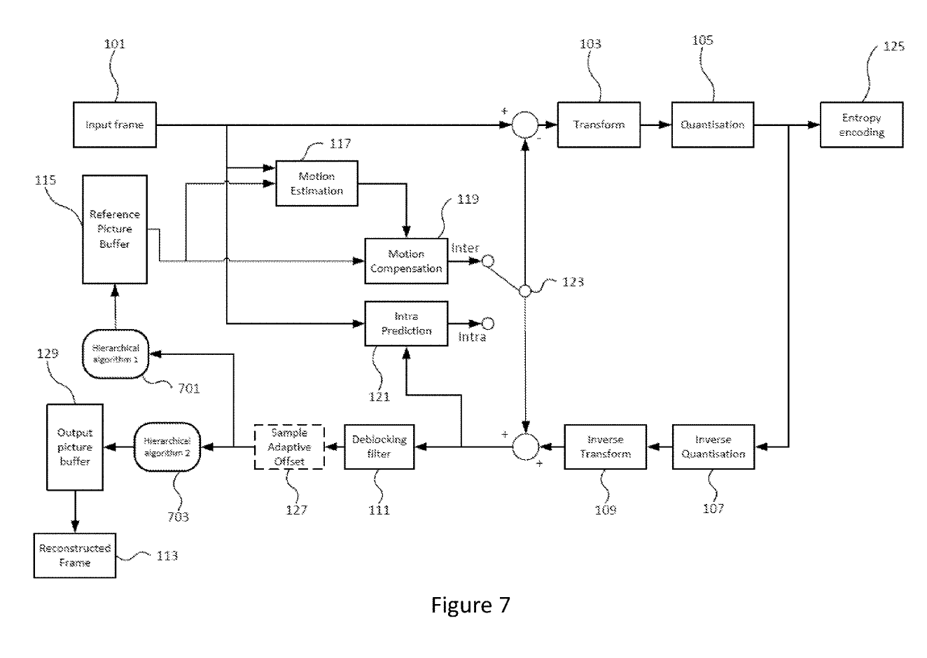

FIG. 7 illustrates an embodiment of an enhanced encoding process using multiple in-loop hierarchical algorithms 701 and 702. In this embodiment, the output of the Sample Adaptive Offset filter 127 is used as input video data for two separate hierarchical algorithms 701 and 702. The first of these hierarchical algorithms 701 enhances the input video data for use in motion compensation 119 and motion estimation 117, and outputs an enhanced reference picture to a reference picture buffer 115. This enhanced reference picture is substantially mathematically optimised for the purpose of interprediction. The second hierarchical algorithm 703 outputs an enhanced set of reconstructed video data to be stored in a output picture buffer 129, the enhanced reconstructed frame being substantially optimised for display purposes.

Each of these hierarchical algorithms can be selected from a library of pre-trained hierarchical algorithms. The sets of possible first and second hierarchical algorithms can be trained on pairs of reconstructed video data and input pictures. The pairs of input and reconstructed video data can be the same for the training of both sets of algorithms, but different optimisation conditions, such as the use of a different metric, will be used in each case. As another example, different pairs of input and reconstructed video data can be used to train each set of algorithms.

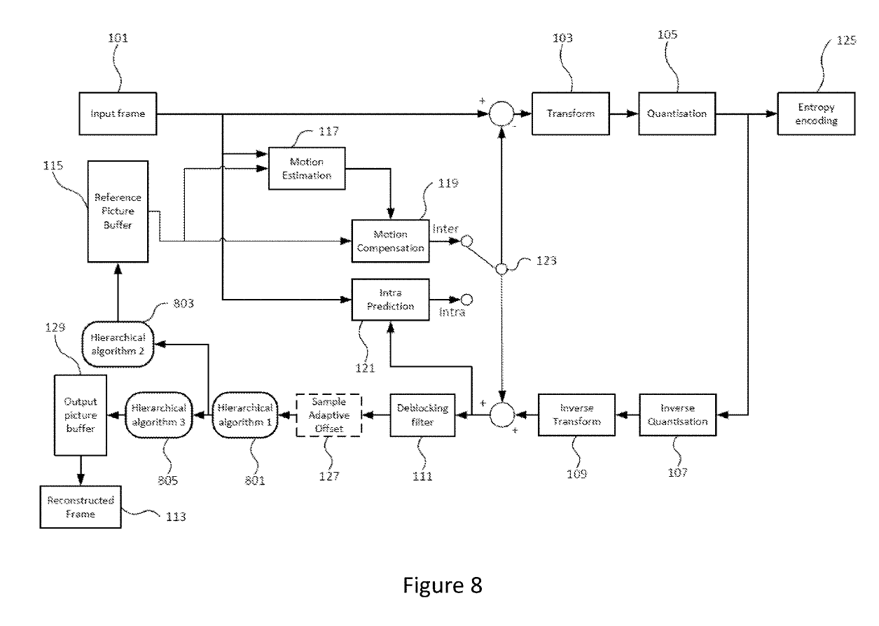

FIG. 8 illustrates another example embodiment of an enhanced encoding process using multiple in-loop hierarchical algorithms 801, 803 and 805. In this embodiment, a first hierarchical algorithm 801 is applied to reconstructed video data after it has been processed by a deblocking filter 111 and SAO filter 127. The output of the first hierarchical algorithm is then used as an input for a second hierarchical algorithm 803 and a third hierarchical algorithm 805. The second hierarchical algorithm 803 outputs an enhanced reference picture, which is stored in a reference picture buffer 115, and is substantially optimised for interprediction. The third hierarchical algorithm 805 outputs reconstructed video data suitable for display to an output picture buffer 129, and which is substantially optimised for visual display.

The different hierarchical algorithms are trained on pairs of reconstructed pictures and input pictures, which do not have to be necessarily temporally co-located. The pairs of input pictures and reconstructed pictures can be the same for the training of both sets of algorithms, but different optimisation conditions, such as the use of a different metric, will be used in each case. In another example, different pairs of input and reconstructed data can be used to train each set of algorithms. In some embodiments, the second hierarchical algorithm 803 and third hierarchical algorithm 805 are trained on input pictures and reconstructed video data, with the first hierarchical algorithm 801 being determined from any common initial layers present in the second hierarchical algorithm 803 and third hierarchical algorithm 805.

Using such an arrangement can be used to increase the efficiency of the method by avoiding processing the reconstructed video data identically in the first few layers of the second and third hierarchical algorithms.

The first 801, second 803 and third 805 hierarchical algorithms can be selected from a library of pre-trained hierarchical algorithms based on metric data associated with the reconstructed video data or input video data 101. The hierarchical algorithms are stored in the library alongside associated metadata relating to the sets of input pictures and reconstructed video data on which they were trained.

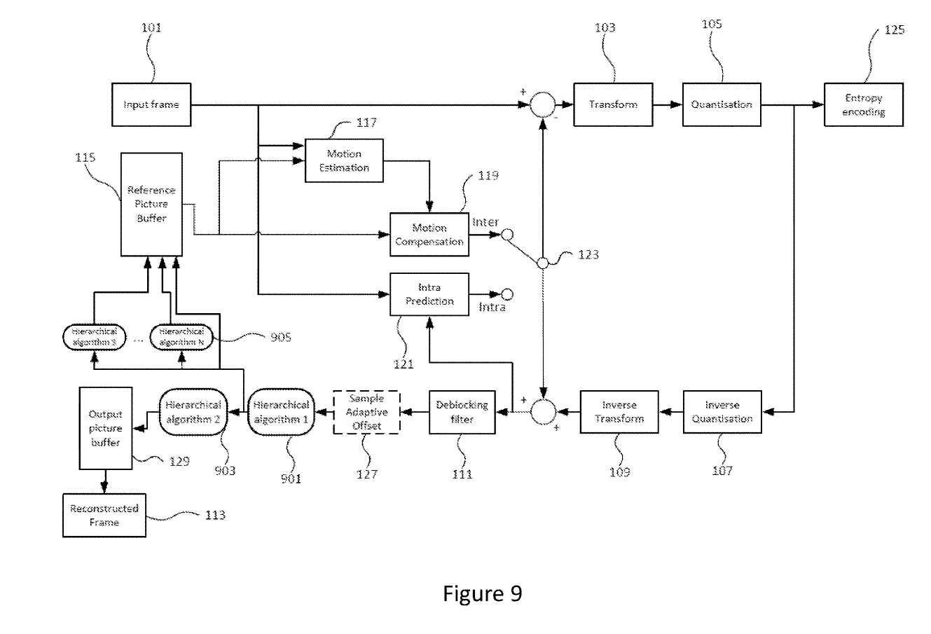

FIG. 9 illustrates an embodiment of an enhanced encoding process using multiple in-loop hierarchical algorithms in parallel. In this embodiment, a first hierarchical algorithm 901 is applied to reconstructed video data after it has been processed by a deblocking filter 111 and SAO filter 127. The output of this first hierarchical algorithm is used as the input of a second hierarchical algorithm 903, which outputs video data suitable for display to a output picture buffer 129, and series of further hierarchical algorithms 905, which output one or more enhanced reference pictures to a reference picture buffer 115. This multiplies the buffer size depending on the number of enhanced reference pictures generated. The series of further hierarchical algorithms 905 may share a number of layers in common, for example, initial layers, in which case these may be combined into one or more shared layers, which can reduce the computational complexity of the process. Furthermore, the output of the first hierarchical algorithm 901 can be stored in the reference picture buffer 115 without any further processing.

The series of further hierarchical algorithms 905 operate in parallel for computational efficiency. Each of the series of hierarchical algorithms 905, as well as the first 901 and second 903 hierarchical algorithms, can be selected from a library of pre-trained hierarchical algorithms that have been trained on known input pictures and reference pictures or reconstructed output pictures. The algorithms are selected based on comparing metric data associated with the input picture 101 or reconstructed video data with metadata associated with the trained hierarchical algorithms that relates to the pictures on which they were trained. Each of the series of further hierarchical algorithms 905 can be selected based on different content present in the input frame 101 or reconstructed video data.

In some embodiments, this can be considered as a hierarchical algorithm being applied to the picture on a block-by-bock basis where the first layers are shared between all blocks and executed on the full picture.

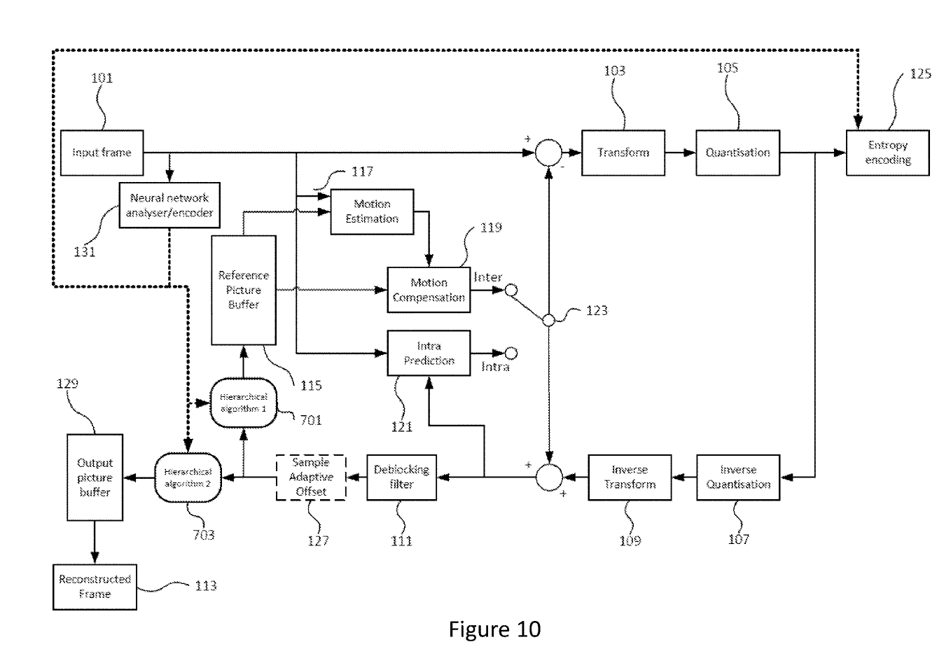

FIG. 10 illustrates an embodiment of an enhanced encoding process using multiple in-loop hierarchical algorithms with a pre-processing module. In this embodiment, the input frame is additionally input into a network analyser/encoder 131 which analyses its content and properties. The network analyser/encoder 131 derives hierarchical algorithm coefficients or indices from the input picture and outputs them to pre-defined hierarchical algorithms used in the in-loop post-processing steps. The network analyser/encoder evaluates the bit rate required to transmit these coefficients and estimates the quality gain (reduction in distortion between the original and reconstructed pictures). Based on the required bit rate and quality gain, the encoder can decide to limit the amount of coefficients to be updated to improve the rate-distortion characteristics of the encoder. In the embodiment shown, a first hierarchical algorithm 701 and a second hierarchical algorithm 703 are used, similar to the embodiment shown in FIG. 7; however the network analyser/encoder 131 can be used as an addition to any of the embodiments herein described.

The network analyser/encoder 131 also transmits the determined coefficients or indices to an entropy encoding module so that they can be encoded and transmitted to a decoder as part of an encoded bitstream. In another example, the determined coefficients or indices can be transmitted to a decoder using a dedicated side channel, such as metadata in an app.

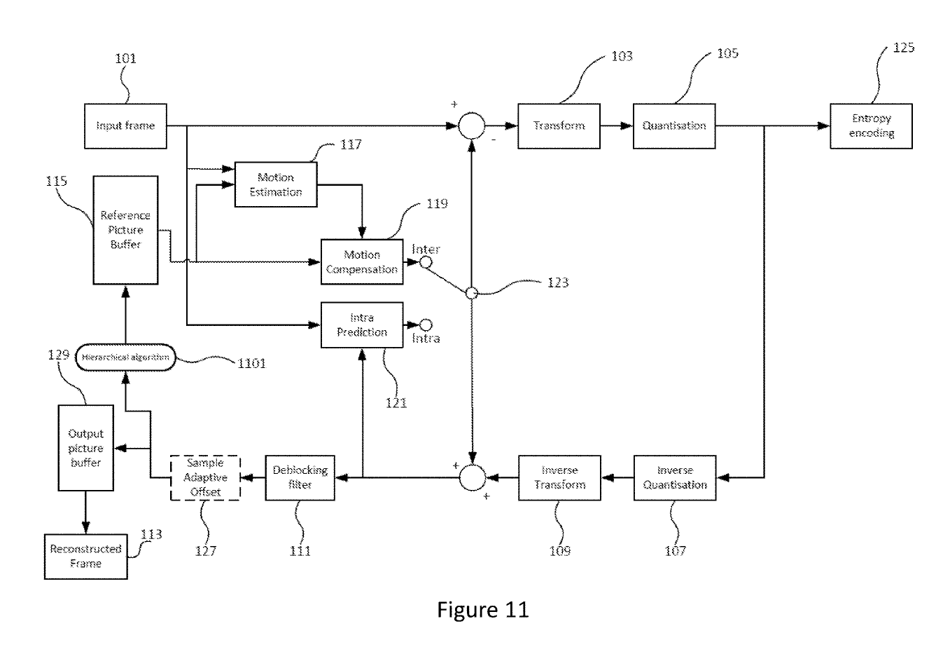

FIG. 11 illustrates an embodiment of an enhanced encoding process using an in-loop hierarchical algorithm 1101 to enhance a reference picture. In this embodiment, an output picture of the deblocking filter 111 and/or Sample Adaptive Offset filter 127 is output directly to the output picture buffer 129 as a reconstructed frame. However, it is also used as an input for a hierarchical algorithm 1101 to generate an enhanced reference picture, which is then stored in the reference picture buffer 115. The hierarchical algorithm 1101 can be applied to the whole of the output picture, or parts of the output picture.

In this embodiment, one example of training the hierarchical algorithm 1101 is to use uncompressed input pictures and reconstructed decoded pictures, which are temporally non-co-located.

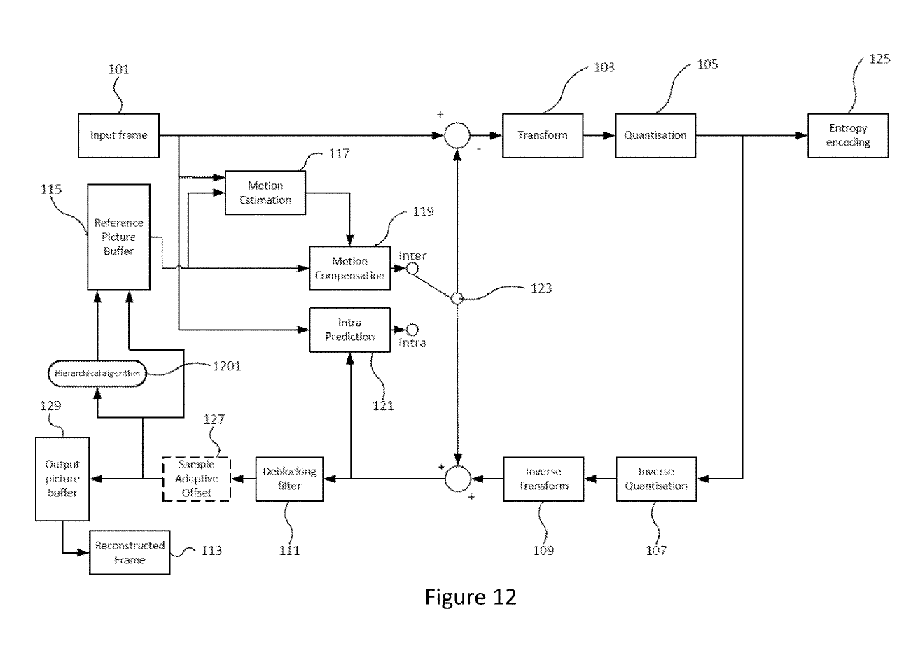

FIG. 12 illustrates another example embodiment of an enhanced encoding process using a hierarchical algorithm 1201 to enhance a reference picture. In this embodiment, an output picture of the deblocking filter 111 and/or Sample Adaptive Offset filter 127 is output directly to the output picture buffer 129 as a reconstructed frame and directly to the reference picture buffer 115. However, in parallel, it is also used as an input for a hierarchical algorithm 1201 to generate an enhanced reference picture, which is then also stored in the reference picture buffer 115. The hierarchical algorithm 1201 can be applied to the whole of the output picture, or to parts of the output picture.

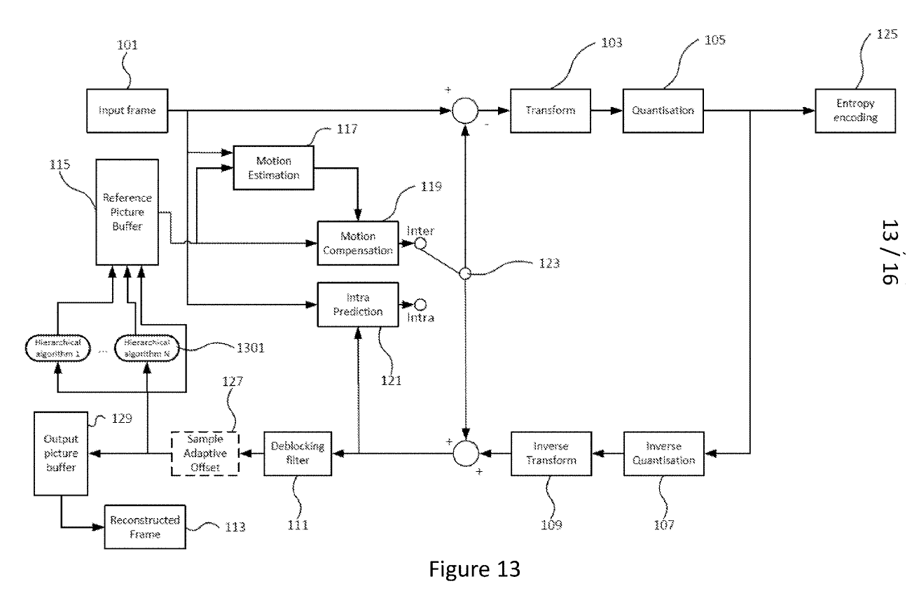

FIG. 13 illustrates an embodiment of an enhanced encoding process using multiple in-loop hierarchical algorithms 1301 to enhance a reference picture. In this embodiment, an output picture of the deblocking filter 111 and/or Sample Adaptive Offset filter 127 is output directly to the output picture buffer 129 as a reconstructed frame and may optionally be output directly to the reference picture buffer 115 without any further processing. The output picture is additionally used as an input for multiple hierarchical algorithms 1301, which operate in parallel, and each of which outputs an enhanced reference picture for storage in the reference picture buffer 115. Each of the multiple hierarchical algorithms 1301 can be applied to the whole of the output picture, or to parts of the output picture.

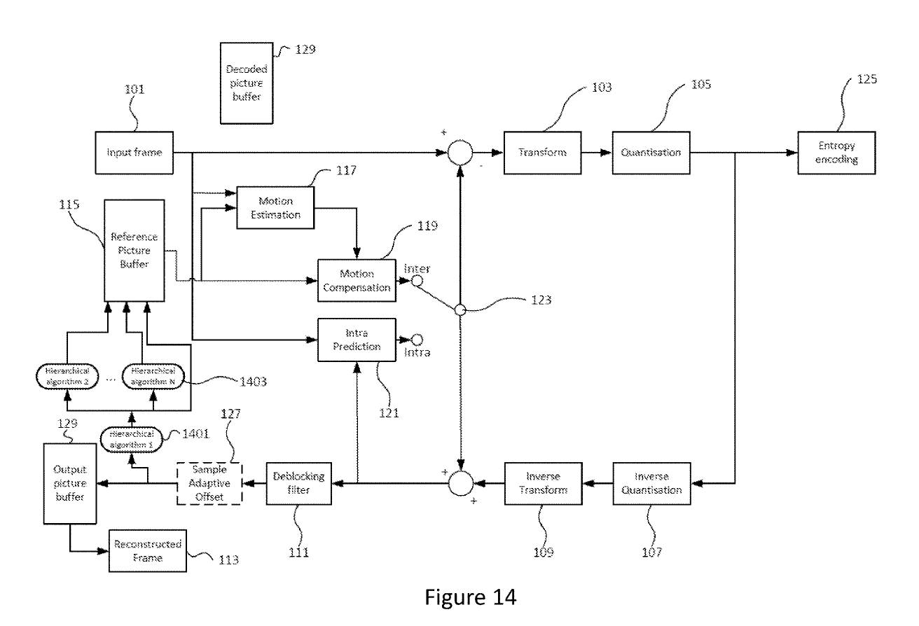

FIG. 14 illustrates an embodiment of another example enhanced encoding process using multiple in-loop hierarchical algorithms to enhance a reference picture. In this embodiment, an output picture of the deblocking filter 111 and/or Sample Adaptive Offset filter 127 is output directly to the output picture buffer 129 as a reconstructed frame and may optionally be output directly to the reference picture buffer 115 without any further processing. The output picture is additionally used as an input for a first hierarchical algorithm 1401, the output of which is then used as an input for multiple further hierarchical algorithms 1403. The multiple further hierarchical algorithms 1403 operate in parallel, and each of the multiple hierarchical algorithms 1403 outputs an enhanced reference picture for storage in the reference picture buffer 115. Each of the multiple hierarchical algorithms 1403 can be applied to the whole of the output picture, or to parts of the output picture. The first hierarchical algorithm 1401 constitutes a series of shared initial layers for the further multiple hierarchical algorithms 1403, and can increase the computational efficiency of the process by performing any common processes in the first hierarchical algorithm 1401. In some embodiments, this can be considered as a hierarchical algorithm on a block-by-bock basis where the first layers are shared between all blocks and executed on the full picture.

In all of the embodiments described in relation to FIGS. 11 to 14, the hierarchical algorithms used can be selected from a library of pre-trained hierarchical algorithms.

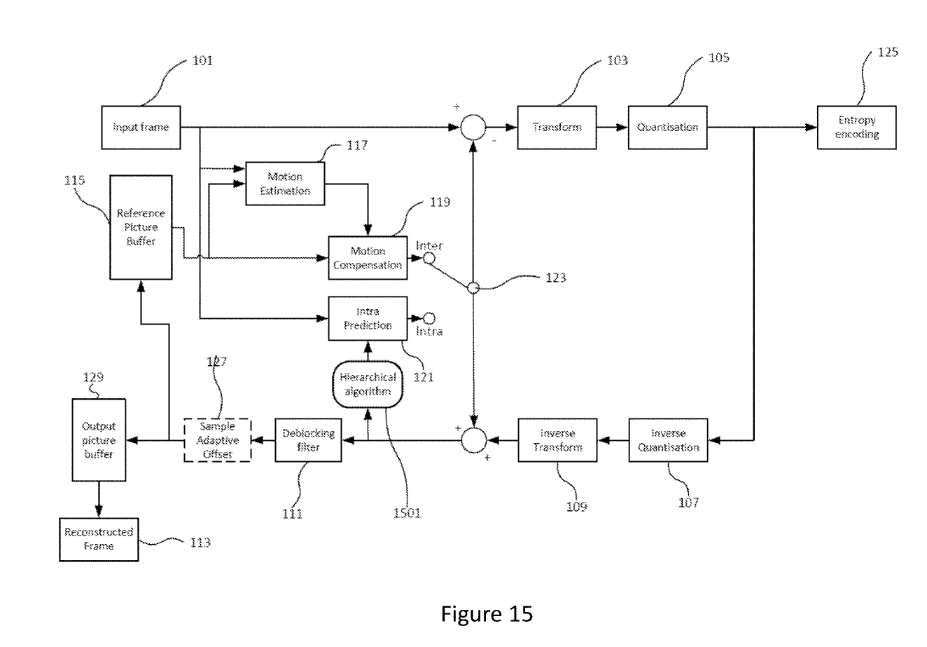

FIG. 15 illustrates an embodiment of an enhanced encoding process using an in-loop hierarchical algorithm 1501 to enhance the intraprediction process. In this embodiment, reconstructed and/or decoded pixels of blocks of video data are input into hierarchical algorithm 1501, which outputs an enhanced set of pixels or blocks of video data for use in intraprediction 121. The hierarchical algorithm 1501 has been pre-trained to output a full patch of samples and use that as the basis for intraprediction 121. A different hierarchical algorithm can be used for each set of pixels or block of video data, with the hierarchical algorithm being chosen from a library of hierarchical algorithms based on the content of the reconstructed pixels or block of video data. In another example, different hierarchical algorithms can be applied to parts of the selected block of video data that are not yet encoded to predict the content based on the available texture information. This can involve complex texture prediction.

The applied hierarchical algorithm 1501 can be trained to define a reduced search window for intraprediction 121 in order to reduce the computational time required to perform intraprediction 121. In another example, the hierarchical algorithm 1501 can be trained to define an optimal search path within a search window.

The embodiment of FIG. 15 can be combined with any of the embodiments in FIGS. 7 to 15, so that both the interprediction and intraprediction 121 processes include the use of hierarchical algorithms to optimise them during the encoding loop. In general, different pre-defined hierarchical algorithms will be applied for intra-coded blocks in inter-predicted pictures.

All of the above embodiments can use pre-defined hierarchical algorithms, such as a learned network or set of filter coefficients, which can be indicated by the encoder to a decoder through an index to a set of pre-defined operations or algorithms, for example a library reference. Furthermore, updates to the pre-determined operations stored at a decoder can be signalled to the decoder by the encoder, using either the encoded bitstream or a sideband. These updates can be determined using self-learning.

Furthermore, all of the above embodiments can be performed at a node within a network, such as a server connected to the internet, with an encoded bitstream generated by the overall encoding process being transmitted across the network to a further node, where the encoded bitstream can be decoded by a decoder present at that node. The encoded bitstream can contain data relating to the hierarchical algorithm or algorithms used in the encoding process, such as a reference identifying which hierarchical algorithms stored in a library at the receiving node are required, or a list of coefficients for a known hierarchical algorithm. This data may be signalled in a sideband, such as metadata in an app. If a referenced hierarchical algorithm is not present at the receiving/decoding node, then the node retrieves the algorithm from the transmitting node, or any other network node at which it is stored.

Any system feature as described herein may also be provided as a method feature, and vice versa. As used herein, means plus function features may be expressed, for example, in terms of their corresponding structure.

Any feature in one aspect of the disclosure may be applied to other aspects of the disclosure, in any appropriate combination. For example, method aspects may be applied to system aspects, and vice versa. Furthermore, any, some and/or all features in one aspect can be applied to any, some and/or all features in any other aspect, in any appropriate combination.

It should also be appreciated that some combinations of the various features described and defined in any aspects of the disclosure can be implemented and/or supplied and/or used independently.

Some of the example embodiments are described as processes or methods depicted as diagrams. Although the diagrams describe the operations as sequential processes, operations may be performed in parallel, or concurrently or simultaneously. In addition, the order or operations may be re-arranged. The processes may be terminated when their operations are completed, but may also have additional steps not included in the figures. The processes may correspond to methods, functions, procedures, subroutines, subprograms, etc.

Methods discussed above, some of which are illustrated by the diagrams, may be implemented by hardware, software, firmware, middleware, microcode, hardware description languages, or any combination thereof. When implemented in software, firmware, middleware or microcode, the program code or code segments to perform the relevant tasks may be stored in a machine or computer readable medium such as a storage medium. A processing apparatus may perform the relevant tasks.

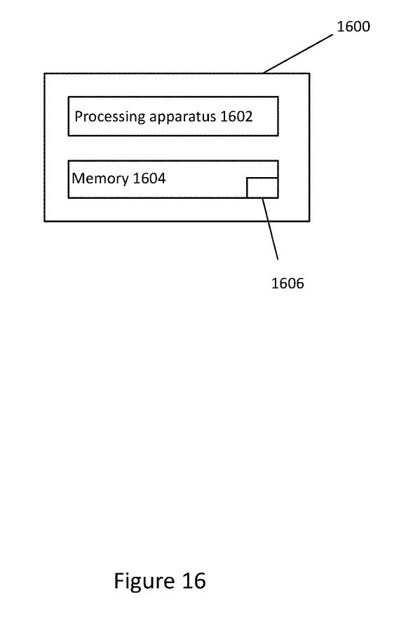

FIG. 16 shows an apparatus 1600 comprising a processing apparatus 1602 and memory 1604 according to an exemplary embodiment. Computer-readable code 1606 may be stored on the memory 1604 and may, when executed by the processing apparatus 1602, cause the apparatus 1600 to perform methods as described here, for example a method with reference to FIGS. 5 to 9.

The processing apparatus 1602 may be of any suitable composition and may include one or more processors of any suitable type or suitable combination of types. Indeed, the term “processing apparatus” should be understood to encompass computers having differing architectures such as single/multi-processor architectures and sequencers/parallel architectures. For example, the processing apparatus may be a programmable processor that interprets computer program instructions and processes data. The processing apparatus may include plural programmable processors. The processing apparatus may be, for example, programmable hardware with embedded firmware. The processing apparatus may include Graphics Processing Units (GPUs), or one or more specialised circuits such as field programmable gate arrays FPGA, Application Specific Integrated Circuits (ASICs), signal processing devices etc. In some instances, processing apparatus may be referred to as computing apparatus or processing means.

The processing apparatus 1602 is coupled to the memory 1604 and is operable to read/write data to/from the memory 1604. The memory 1604 may comprise a single memory unit or a plurality of memory units, upon which the computer readable instructions (or code) is stored. For example, the memory may comprise both volatile memory and non-volatile memory. In such examples, the computer readable instructions/program code may be stored in the non-volatile memory and may be executed by the processing apparatus using the volatile memory for temporary storage of data or data and instructions. Examples of volatile memory include RAM, DRAM, and SDRAM etc. Examples of non-volatile memory include ROM, PROM, EEPROM, flash memory, optical storage, magnetic storage, etc.

An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Methods described in the illustrative embodiments may be implemented as program modules or functional processes including routines, programs, objects, components, data structures, etc., that perform some tasks or implement some functionality, and may be implemented using existing hardware. Such existing hardware may include one or more processors (e.g. one or more central processing units), digital signal processors (DSPs), application-specific-integrated-circuits, field programmable gate arrays (FPGAs), computers, or the like.

Unless specifically stated otherwise, or as is apparent from the discussion, terms such as processing or computing or calculating or determining or the like, refer to the actions and processes of a computer system, or similar electronic computing device. Note also that software implemented aspects of the example embodiments may be encoded on some form of non-transitory program storage medium or implemented over some type of transmission medium. The program storage medium may be magnetic (e.g. a floppy disk or a hard drive) or optical (e.g. a compact disk read only memory, or CD ROM), and may be read only or random access. Similarly the transmission medium may be twisted wire pair, coaxial cable, optical fibre, or other suitable transmission medium known in the art. The example embodiments are not limited by these aspects in any given implementation.

Further implementations are summarized in the following examples:

### EXAMPLE 1

A method of post filtering video data in an encoding and/or decoding process using hierarchical algorithms, the method comprising steps of:

receiving one or more input pictures of video data;

transforming, using one or more hierarchical algorithms, the one or more input pictures of video data to one or more pictures of transformed video data; and

outputting the one or more transformed pictures of video data;

wherein the transformed pictures of video data are enhanced for use within the encoding and/or decoding loop and wherein the method is performed in-loop within the encoding and/or decoding process.

### EXAMPLE 2

A method according to any preceding example, wherein a plurality of hierarchical algorithms is applied to the one or more input pictures of video data.

### EXAMPLE 3

A method according to example 2, wherein two or more of the plurality of hierarchical algorithms share one or more layers.

### EXAMPLE 4

A method according to any preceding example, wherein the transformed pictures of video data are enhanced for use in motion compensation.

### EXAMPLE 5

A method according to any preceding example, further comprising the step of applying a non-hierarchical in-loop filter to the one or more input pictures of video data.

### EXAMPLE 6

A method according to example 5, wherein the non-hierarchical in-loop filter is incorporated into the one or more hierarchical algorithms.

### EXAMPLE 7

A method according to any of examples 1 to 4, further comprising the step of applying a non-hierarchical in-loop filter to the one or more transformed pictures of video data.

### EXAMPLE 8

A method according to any of examples 5 to 7, wherein the non-hierarchical in-loop filter comprises at least one of: a deblocking filter; a Sample Adaptive Offset filter; an Adaptive Loop Filter; or a Wiener filter.

### EXAMPLE 9

A method according to any preceding example, wherein the one or more transformed pictures of video data are stored in one or more buffers after being output by the one or more hierarchical algorithms.

### EXAMPLE 10

A method according to example 9 wherein the one or more buffers comprises at least one of: a reference picture buffer; and output picture buffer; or a decoded picture buffer.

### EXAMPLE 11

A method according to examples 9 or 10, wherein one or more further hierarchical algorithms are applied to the one or more transformed pictures of video data prior to the one or more transformed pictures of video data being stored in at least one of the one or more buffers.

### EXAMPLE 12

A method according to example 11, wherein the one or more further hierarchical algorithms comprises a plurality of further hierarchical algorithms.

### EXAMPLE 13

A method according to example 12, wherein two or more of the plurality of further hierarchical algorithms are applied in parallel.

### EXAMPLE 14

A method according to examples 12 or 13, wherein two or more of the plurality of further hierarchical algorithms share one or more layers.

### EXAMPLE 15

A method according to any preceding example, wherein the transformed pictures of video data are enhanced for use in intraprediction.

### EXAMPLE 16

A method according to example 15, wherein the transformed pictures of video data are output to an intraprediction module.

### EXAMPLE 17

A method according to examples 15 or 16, wherein the one or more hierarchical algorithms comprises a plurality of hierarchical algorithms.

### EXAMPLE 18

A method according to example 17, wherein each of the plurality of hierarchical algorithms is applied at a separate set of input blocks in the input picture.

### EXAMPLE 19

A method according to examples 17 or 18, wherein a separate hierarchical algorithm is applied to each of two or more input blocks of video data in the input picture of video data.

### EXAMPLE 20

A method according to any preceding example, wherein one or more of the one or more hierarchical algorithms are selected from a library of pre-trained hierarchical algorithms.

### EXAMPLE 21

A method according to example 20, wherein the selected one or more hierarchical algorithms are selected based on metric data associated with the one or more input pictures of video data.

### EXAMPLE 22

A method according to examples 20 or 21, further comprising the step of pre-processing the input picture of video data to determine which of the one or more hierarchical algorithms are selected.

### EXAMPLE 23

A method according to example 22, wherein the step of pre-processing the input picture further comprises determining one or more updates to the selected one or more hierarchical algorithms.

### EXAMPLE 24

A method according to any preceding example, wherein the one or more hierarchical algorithms are content specific.

### EXAMPLE 25

A method according to any preceding example, wherein the one or more hierarchical algorithms were developed using a learned approach.

### EXAMPLE 26

A method according to example 25, wherein the learned approach comprises training the hierarchical algorithm on uncompressed input pictures and reconstructed decoded pictures.

### EXAMPLE 27

A method according to any preceding example, wherein the hierarchical algorithm comprises: a nonlinear hierarchical algorithm; a neural network; a convolutional neural network; a layered algorithm; a recurrent neural network; a long short-term memory network; a 3D convolutional network; a memory network; or a gated recurrent network.

### EXAMPLE 28

A method according to any preceding example, wherein the method is performed at a node within a network.

### EXAMPLE 29

A method according to example 28, wherein metadata associated with the one or more hierarchical algorithms is transmitted across the network.

### EXAMPLE 30

A method according to example 28 or 29, wherein one or more of the one or more hierarchical algorithms are transmitted across the network.

### EXAMPLE 31

A method substantially as hereinbefore described in relation to the FIGS. 7 to 15.

### EXAMPLE 32

Apparatus comprising:

at least one processor;

at least one memory including computer program code which, when executed by the at least one processor, causes the apparatus to perform the method of any one of examples 1 to 31.

### EXAMPLE 33

A computer readable medium having computer readable code stored thereon, the computer readable code, when executed by at least one processor, causing the performance of the method of any one of examples 1 to 31.

What is claimed is:

1. A method of post filtering video data in an encoding or decoding process using hierarchical algorithms, comprising:
receiving one or more input pictures of video data;
transforming, using one or more hierarchical algorithms, the one or more input pictures of video data to one or more pictures of transformed video data; and
outputting the one or more transformed pictures of video data;
wherein the transformed pictures of video data are enhanced for use within the encoding or decoding loop and wherein the method is performed in-loop within the encoding or decoding process.

2. The method of claim 1, wherein a plurality of hierarchical algorithms is applied to the one or more input pictures of video data.

3. The method of claim 2, wherein two or more of the plurality of hierarchical algorithms share one or more layers.

4. The method of claim 1, wherein the transformed pictures of video data are enhanced for use in motion compensation.

5. The method of claim 1, further comprising:
applying a non-hierarchical in-loop filter to the one or more input pictures of video data.

6. The method of claim 5, wherein the non-hierarchical in-loop filter is incorporated into the one or more hierarchical algorithms.

7. The method of claim 1, further comprising:
applying a non-hierarchical in-loop filter to the one or more transformed pictures of video data.

8. The method of claim 1, further comprising applying a non-hierarchical in-loop filter to the one or more input pictures of video data or applying a non-hierarchical in-loop filter to the one or more transformed pictures of video data, and wherein the non-hierarchical in-loop filter comprises at least one of: a deblocking filter, a Sample Adaptive Offset filter, an Adaptive Loop Filter, or a Wiener filter.

9. The method of claim 1, wherein the one or more transformed pictures of video data are stored in one or more buffers after being output by the one or more hierarchical algorithms.

10. The method of claim 9 wherein the one or more buffers comprises at least one of: a reference picture buffer; and output picture buffer; or a decoded picture buffer.

11. The method of claim 9, wherein one or more further hierarchical algorithms are applied to the one or more transformed pictures of video data prior to the one or more transformed pictures of video data being stored in at least one of the one or more buffers.

12. The method of claim 11, wherein the one or more further hierarchical algorithms comprises a plurality of further hierarchical algorithms.

13. The method of claim 12, wherein two or more of the plurality of further hierarchical algorithms are applied in parallel.

14. The method according to claim 12, wherein two or more of the plurality of further hierarchical algorithms share one or more layers.

15. The method of claim 1, wherein the transformed pictures of video data are enhanced for use in intraprediction.

16. The method of claim 15, wherein the transformed pictures of video data are output to an intraprediction module.

17. The method of claim 15, wherein the one or more hierarchical algorithms comprises a plurality of hierarchical algorithms.

18. The method of claim 17, wherein each of the plurality of hierarchical algorithms is applied at a separate set of input blocks in the input picture.

19. An apparatus for post filtering video data in an encoding or decoding process using hierarchical algorithms, comprising:
at least one processor; and
at least one memory including computer program code which, when executed by the at least one processor, causes the apparatus to:
receive one or more input pictures of video data;
transform, using one or more hierarchical algorithms, the one or more input pictures of video data to one or more pictures of transformed video data; and
output the one or more transformed pictures of video data;
wherein the transformed pictures of video data are enhanced for use within the encoding or decoding loop and wherein the method is performed in-loop within the encoding or decoding process.

20. A computer readable medium having computer readable code stored thereon for post filtering video data in an encoding or decoding process using hierarchical algorithms, the computer readable code, when executed by at least one processor, cause the at least one processor to:
receive one or more input pictures of video data;
transform, using one or more hierarchical algorithms, the one or more input pictures of video data to one or more pictures of transformed video data; and
output the one or more transformed pictures of video data;
wherein the transformed pictures of video data are enhanced for use within the encoding or decoding loop and wherein the method is performed in-loop within the encoding or decoding process.
